(19) United States
(12) Patent Application Publication
(10) Pub. No.: US 2021/0048601 A1
(43) Pub. Date: Feb. 18, 2021

(54) LENS MODULE

(71) Applicant: AAC Optics Solutions Pte. Ltd., Singapore City (SG)

(72) Inventor: Yuchan Gao, Shenzhen (CN)

(21) Appl. No.: 16/992,050

(22) Filed: Aug. 12, 2020

(30) Foreign Application Priority Data
Aug. 15, 2019 (CN) 201921327712.9

(51) Int. Cl. G02B 7/02; G02B 13/18

(52) U.S. Cl. CPC G02B 7/026; G02B 7/021; G02B 13/18

(57) ABSTRACT

The present disclosure relates to a lens module, including a lens barrel having an accommodating space, a lens group accommodated in the accommodating space and a stopper that fixes the lens group in the lens barrel from an image side of the lens group. The stopper is fixed with the lens barrel by welding. The lens module provided in the present disclosure is fixed and welded with a lens barrel through a stopper, which is stable and reliable and effectively improves thrust of the lens barrel, strengthens stability of the lens module and improves reliability of falling. Besides, it is unnecessary to reserve dispensing grooves and position to match the stopper on the barrel wall. Accordingly, the lens barrel can be as short as possible, thereby avoiding stray light on the side wall of the mouth of the lens barrel.

### TECHNICAL FIELD

The present disclosure relates to the technical field of optical imaging, in particular a lens module.

### BACKGROUND

With continuous development of science and technology, electronic devices are developing intelligently. In addition to digital cameras, portable electronic devices such as tablet computers, mobile phones, etc. are also equipped with lens modules for shooting in order to meet users' needs in taking pictures at any time.

A lens module in a related art includes a lens barrel, a lens group and a stopper that are accommodated in the lens barrel. The stopper is fixedly connected with the lens barrel and presses the lens group in the lens barrel.

However, the stopper and the lens barrel in the related art are fixed by glue, which is not reliable because glue connection is limited by glue properties and adhering area. Besides, it is required to reserve dispensing grooves and positions to match the stopper on the lens barrel, which limits the length of a lens barrel and the size of a mechanical back focal length. Consequently, it is easy to result in stray light on the side wall of the mouth of the lens barrel.

Therefore, it is necessary to provide a new lens module to solve the above problems.

### SUMMARY

With regard to the technical problem of poor reliability of a lens module due to fixing manner of dispensing glue between a stopper and a lens barrel in a lens module in the prior art, the present disclosure provides a more reliable lens module.

A lens module, including a lens barrel having an accommodating space, a lens group accommodated in the accommodating space and a stopper that fixes the lens group in the lens barrel from an image side of the lens group. Herein, the stopper is fixed with the lens barrel by welding.

Preferably, the lens group includes a first lens adjacent to the stopper, and the stopper is respectively fixed with the first lens and the lens barrel by welding.

Preferably, the lens barrel includes a first barrel wall having a light penetrating hole and a second barrel wall bending and extending from the first barrel wall, the second barrel wall includes an inner surface that forms the accommodating space cooperatively with the first barrel wall and an image-side surface bending and extending from an end of the inner surface along a direction away from an optical axis, the end being adjacent to the image side, and the stopper is welded to the image-side surface correspondingly.

Preferably, the first lens includes an optical portion for imaging and a peripheral portion extending outwards from the optical portion, and the stopper is welded to the peripheral portion correspondingly.

Preferably, the peripheral portion includes a first surface adjacent to an object side, a second surface adjacent to the image side, and a third surface connecting the first surface and the second surface, the second surface is coplanar with the image-side surface, the third surface correspondingly abuts against the inner surface, and the stopper is welded to the second surface correspondingly.

Preferably, the lens module further includes a shielding plate accommodated in the accommodating space, and the first surface correspondingly abuts against the shielding plate.

Preferably, the stopper includes a fourth surface adjacent to the object side. A side of the fourth surface adjacent to the optical axis is correspondingly welded to the second surface. A side of the fourth surface away from the optical axis is correspondingly welded to the image-side surface.

Preferably, the stopper is fixedly connected to the lens barrel and the first lens by ultrasonic welding, laser welding, friction welding or vibration welding.

Preferably, the stopper is annular, and a central axis or the stopper is coincident with the optical axis.

Compared with a related art, the lens module provided in the present disclosure is fixed and welded with a lens barrel through a stopper, which is stable and reliable and effectively improves thrust of the lens barrel, strengthens stability of the lens module and improves reliability of falling. Besides, since the stopper and the lens barrel are fixed by welding, it is unnecessary to reserve dispensing grooves and position to match the stopper on the barrel wall. Accordingly, the lens barrel can be as short as possible, thereby avoiding stray light on the side wall of the mouth of the lens barrel.

### BRIEF DESCRIPTION OF THE DRAWINGS

In order to illustrate the technical solutions in the embodiments of the present disclosure more clearly, the drawings used in the description of the embodiments will be briefly described below. It is obvious that the drawings in the following description are only some embodiments of the present disclosure. For those skilled in the art, other drawings may also be obtained in accordance with the drawings without any inventive effort.

FIG. 1 is a schematic structural view of a lens module provided in the present disclosure;

FIG. 2 is a partially enlarged view of area II as shown in FIG. 1.

### DETAILED DESCRIPTION

A clear and complete description is provided on the technical solutions in embodiments of the present disclosure with reference to the drawings for the embodiments of the present disclosure. Obviously, the embodiments described are only some rather than all embodiments of the present disclosure. On the basis of the embodiments of the present disclosure, all the other embodiments obtained by those skilled in the art without any inventive effort fall into the scope of the present disclosure.

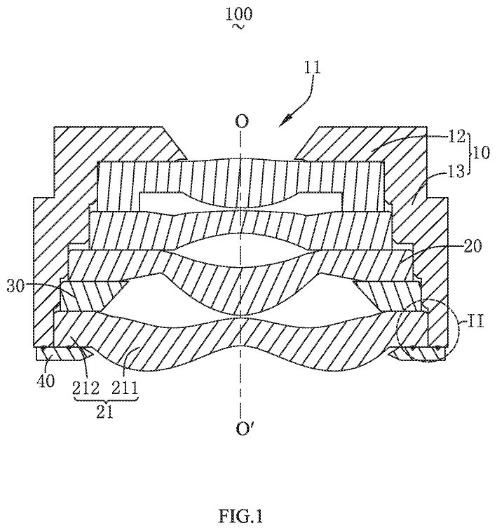

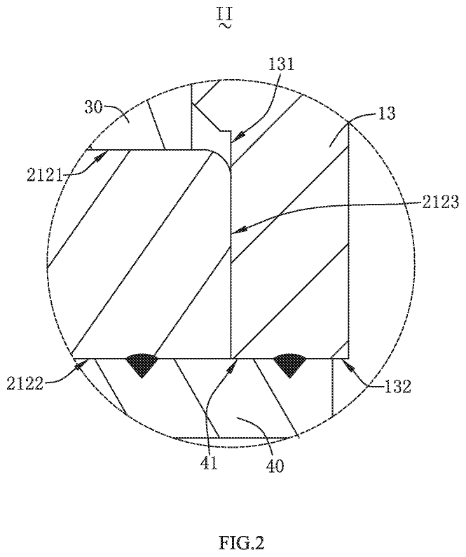

With reference to FIG. 1 and FIG. 2, the present disclosure provides a lens module 100. The lens module 100 can be applied to portable devices such as cameras and mobile phones. The lens module 100 includes a lens barrel 10 having an accommodating space, a lens group 20 and a shielding plate 30 accommodated in the accommodating space, and a stopper 40 that fixes the lens group 20 in the lens barrel 10 from an image side of the lens group 20.

The lens barrel 10 includes a first barrel wall 12 having lens penetrating hole 11 and a second barrel wall 13 bending and extending from the first barrel wall 12 to an image side. The light penetrating hole 11 is communicated to the accommodating space.

The second barrel wall 13 includes an inner surface 131 that forms the accommodating space cooperatively with the first barrel wall 12, and an image-side surface 132 bending and extending from an end of the inner surface 131 along a direction away from an optical axis OO′, the end being adjacent to the image side.

The lens group 20 includes a first lens 21 adjacent to the stopper 40. It shall be noted that in this embodiment, the lens group 20 includes four lenses. Herein, a lens adjacent to the stopper 40 is designated as the first lens 21. Alternatively, in anther embodiment, there can be any number of lenses in the lens group 20. In this embodiment, four lenses is taken as an example for description. Besides, in this embodiment, there is one shielding plate 30 and the shielding plate 30 is disposed close to the first lens 21. Alternatively, in another embodiment, the number and positions of the shielding plate 30 can be random based on practical needs. In this embodiment, one shielding plate 30 close to the first lens 21 is taken as an example for description. Besides, in another embodiment, a shielding sheet can be disposed between two neighboring lenses based on practical needs to avoid stray light.

The first lens 21 includes an optical portion 211 for imaging and a peripheral portion 212 extending outwards from the optical portion 211.

The peripheral portion 212 includes a first surface 2121 adjacent to an object side, a second surface 2122 adjacent to the image side, and a third surface 2123 connecting the first surface 2121 and the second surface 2122. The first surface 2121 correspondingly abuts against the shielding plate 30, the second surface 2122 is coplanar with the image-side surface 132, and the third surface 2123 correspondingly abuts against the inner surface 131.

The stopper 40 is respectively fixed with the lens barrel 10 and the first lens 21 by welding. Specifically, the stopper 40 is fixedly connected with the lens barrel 10 and the first lens 21 by ultrasonic welding, laser welding, friction welding or vibration welding.

The stopper 40 includes a fourth surface 41 adjacent to the object side. The fourth surface 41 is respectively and correspondingly welded with the image-side surface 132 and the second surface 2122. Specifically, a side of the fourth surface 41 is correspondingly welded to the second surface 2122, the side being adjacent to the optical axis OO′, and a side of the fourth surface 41 is correspondingly welded to the image-side surface 132, the side beding away from the optical axis OO′. It can be understood that since the second surface 2122 is coplanar with the image-side surface 132, after being welding together, a force between the stopper 40 and the lens barrel 10 and a force between the stopper 40 and the first lens 21 are more balanced, which can effectively improve stability of connection.

It shall be noted that in this embodiment, the stopper 40 is annular, thereby there is a larger welding area between the stopper 40 and the lens barrel 10, which improves stability of connection between the stopper 40 and the lens barrel 10. Preferably, a central axis of the stopper 40 and the optical axis OO′ are on the same line, i.e., the central axis of the stopper 40 is coincident with the optical axis OO′, thereby every side of the stopper 40 may be welded well with the lens barrel 10, which effectively improves stability of connection. Alternatively, in other embodiments, the stopper 40 can be of any shape and structure. In order to save material, the stopper 40 may be of a segmented structure. For example, the stopper 40 may be arc shaped and there are a plurality of stoppers 40. The plurality of arc stoppers 40 can be disposed in an annular array and are respectively welded with the image-side surface 132 and the second surface 2122, and thus capable of saving materials for manufacturing the stoppers 40.

Compared with a related art, the lens module provided in the present disclosure is fixed and welded with a lens barrel through a stopper, which is stable and reliable and effectively improves thrust of the lens barrel, strengthens stability of the lens module and improves reliability of falling. Besides, since the stopper and the lens barrel are fixed by welding, it is unnecessary to reserve dispensing grooves and position to math the stopper on the barrel wall. Accordingly, the lens barrel can be as short as possible, thereby avoiding stray light on the side wall of the mouth of the lens barrel.

The above-described are only embodiments of the present disclosure. It shall be noted that for those skilled in the art, an improvement may be performed without departing from the creative concept of the present disclosure, but the improvement fall into the protection scope of the present disclosure.

What is claimed is:

1. A lens module, comprising a lens barrel having an accommodating space, a lens group accommodated in the accommodating space and a stopper that fixes the lens group in the lens barrel from an image side of the lens group, wherein the stopper is fixed with the lens barrel by welding.

2. The lens module according to claim 1, wherein the lens group comprises a first lens adjacent to the stopper, and the stopper is respectively fixed with the first lens and the lens barrel by welding.

3. The lens module according to claim 2, wherein the lens barrel comprises a first barrel wall having lens penetrating hole and a second barrel wall bending and extending from the first barrel wall, the second barrel wall comprises an inner surface that forms the accommodating space with the first barrel wall and an image-side surface bending and extending from an end of the inner surface along a direction away from an optical axis, the end being adjacent to the image side, and the stopper is welded to the image-side surface correspondingly.

4. The lens module according to claim 3, wherein the first lens comprises an optical portion for imaging and a peripheral portion extending outwards from the optical portion, and the stopper is welded to the peripheral portion are correspondingly.

5. The lens module according to claim 4, wherein the peripheral portion comprises a first surface adjacent to an object side, a second surface adjacent to the image side, and a third surface connecting the first surface and the second surface, the second surface is coplanar with the image-side surface, the third surface correspondingly abuts against the inner surface, and the stopper is welded to the second surface correspondingly.

6. The lens module according to claim 5, wherein the lens module further comprises a shielding plate accommodated in the accommodating space, and the first surface correspondingly abuts against the shielding plate.

7. The lens module according to claim 5, wherein the stopper comprises a fourth surface adjacent to the object side, a side of the fourth surface adjacent to the optical axis is correspondingly welded to the second surface, and a side of the fourth surface away from the optical axis is correspondingly welded to the image-side surface.

8. The lens module according to claim 2, wherein the stopper is fixedly connected to the lens barrel and the first lens by ultrasonic welding, laser welding, friction welding or vibration welding.

9. The lens module according to claim 1, wherein the stopper is annular, and a central axis of the stopper is coincident with the optical axis.
